(19) United States
(12) Patent Application Publication
(10) Pub. No.: US 2009/0121827 A1
(43) Pub. Date: May 14, 2009

(54) PLANT MONITOR-CONTROL SYSTEM AND PLANT MONITOR-CONTROL METHOD

(76) Inventors: Nobuhisa Osaki, Mito (JP); Katsuhito Shimizu, Hitachi (JP); Yoshiaki Niijima, Hitachiota (JP); Yoshinori Teraoka, Hitachi (JP); Kosuke Yamaguchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/265,846

(22) Filed: Nov. 6, 2008

(30) Foreign Application Priority Data
Nov. 8, 2007 (JP) 2007-290538

(51) Int. Cl. G05B 23/02

(52) U.S. Cl. 340/3.1

(57) ABSTRACT

A plant monitor-control system which has a display unit that displays a plurality of plant information screens and menu screens that include plant information titles prepared for each of plant information screens, the display unit displaying thereon desired plant information screens upon selection of the plant information titles in menu screens displayed thereon, thereby permitting monitor and control of a plant according to plant information screens displayed on the display unit. The plant information titles in the menu screens are displayed in the region including a text title display region and a title image display region, the text title display region displaying text titles composed of character strings, the title image display region displaying title images composed of images representing the content of the plant information screens. It permits plant information screens to be displayed easily on the display unit.

### BACKGROUND OF THE INVENTION

1. Field of the Invention

The present invention relates to a plant monitor-control system and a plant monitor-control method to be used to monitor and control the process in a plant. More particularly, the present invention relates to a display of plant information in the display unit intended for plant process monitor and control.

2. Description of the Related Art

Most plants, such as manufacturing plants, electric power plants, and sewage treatment plants, are provided with a plant monitor-control system constructed of computer systems which monitors and controls the plant process and also maintains the plant process. The plant monitor-control system displays plant information on display devices in the form of plant information screens, based on which it monitors and controls the plant process. The plant information is any information about the state of the plant process, and it includes information about the state of various machines and equipment constituting the plant process and also information such as process data obtained from various measuring instruments attached to the plant process.

The plant monitor-control system mentioned above is so designed as to display desired plant information screens on the display devices as the operator selects and specifies them on the menu screen. That is, the plant monitor-control system has plant information titles prepared for each of the plant information screens to be displayed on the display devices, so that the menu screen lists the plant information titles. The menu screen is displayed in compliance with the operator's request. When the menu screen is displayed, the operator specifies the desired plant information screens by means of the plant information title in the menu screen so that they are displayed.

The plant information screens are usually displayed in blocks classified according to the type of plant information. The plant information includes the following.

Graphic information, which is information that relates the current state data of the plant process with the systematic structure of the plant process.
Historical trend information, which is information about the change with time in the state of the plant process. Operation history information, which is information about operation performed on the plant process in the past. Message information, which is a message about the plant process.
Document information, which is information (in the form of document) about the state of the plant process.
Alarm information, which is information about alarms that occur in the plant process.

According to these kinds of information, the plant information screens are divided into graphic information screens, historical trend information screens, operation history information screens, message information screens, document information screens, and alarm information screens. Thus, the menu screens are available in several types according to these kinds of plant information screens. Therefore, the demand for display of the above-mentioned menu screens is usually accomplished by specifying the menu screen of the desired type.

Usually, there is a very large amount of plant information to be handled by the plant monitor-control system. Consequently, the menu screen to be used to display the plant information screens contains a large number of plant information titles. For the plant information screens required by the operator to be displayed, it is necessary to find out the desired plant information screens from a large number of plant information titles in the menu screen. In this case, the fact that the plant information titles are described in the form of character strings causes the operator to take time to make a judgment about the relation between the desired plant information screen (which the operator images in his mind) and the plant information title, or causes the operator to make an erroneous judgment. This has been a factor that prevents the plant information screen from being displayed efficiently.

In view of the foregoing, there have been proposed some methods for making a judgment easily about the plant information title. One method, as disclosed in Patent Document 1, employs as the plant information title an image generated from the plant information screen. That is, this method works in such a manner that the plant information screen held by the plant monitor-control system is reduced in size as such, so that a reduced screen of the plant information screen is generated, and the reduced screens of the plant information screens are listed as the plant information titles in the menus screen. In this way, it is possible to make the plant information title display directly the content of the plant information screen. Other examples of the plant monitor-control system are disclosed in Patent Documents 2 and 3.

### Patent Document 1:

Japanese Patent Laid-open No. Sho-60-227294

### Patent Document 2:

Japanese Patent Laid-open No. 2000-89821

### Patent Document 3:

Japanese Patent Laid-open No. 2006-31301

### OBJECT AND SUMMARY OF THE INVENTION

The method disclosed in Patent Document 1, which employs as the plant information title the reduced screen of the plant information screen, is somewhat effective in displaying the plant information screen efficiently. This method, however, is limited in improving the efficiency of displaying the plant information screen because it employs only the reduced screen of the plant information screen as the plant information title. In other words, many of the plant information screens to be displayed in the plant monitor-control system are similar to one another; therefore, the plant information title resorting to only the reduced screens of the plant information screens presents difficulties in making a judgment of the plant information title for the similar plant information screens. This limits improvement in the efficient display of the plant information screens.

The present invention was completed in view of the foregoing. The object of the present invention is to make the plant information screen in the plant monitor-control system improve in operability.

According to the present invention to tackle the above-mentioned problems, the plant information title consists of title images (which represent the content of plant information screens or plant information) and text titles (which are composed of character strings) which are arranged side by side. The plant information title including title screens and text titles arranged side by side compensate for each other's shortcomings of title images and text titles which present difficulties in interpretation of plant information titles (or text titles present difficulties in grasping the content of the plant information screen and title images present difficulties in interpretation of the plant information title for similar plant information screens). Therefore, it helps the operator to easily handle the plant information screens for their display.

To be specific, the present invention to solve the above-mentioned problems is directed to a plant monitor-control system of the type having a display unit that displays a plurality of plant information screens and menu screens that include plant information titles prepared for each of the plant information screens, the display unit displaying thereon desired plant information screens upon selection of the plant information titles in menu screens displayed thereon, thereby permitting monitor and control of a plant according to plant information screens displayed on the display unit, wherein the plant information titles in the menu screens are displayed in the region including a text title display region and a title image display region, the text title display region displaying text titles composed of character strings, the title image display region displaying title images composed of images representing the content of the plant information screens.

The plant monitor-control system according to the present invention may be modified such that the plant information screens can be displayed on the display unit also by selection of the title image displayed in the title image display region.

The arrangement mentioned above is convenient for selection of the plant information titles and display of the plant information screens.

According to the present invention, the plant monitor-control system mentioned above is characterized in that the title image contains an directly reduced image formed by reducing the plant information screen as such to be displayed by the selection, a feature reduced image formed by reducing the feature extracted from the plant information screen to be displayed by the selection, an equipment symbol image formed with equipment symbols contained in the plant information screen to be displayed by the selection, a text image formed with character strings to briefly represent the content of the plant information screen or the text title to be displayed by the selection, and a free image formed from any image to be produced freely, the title images of various types being used individually according to the content and type of the plant information screens.

The arrangement mentioned above improves the ability of expression of the title image (or the ability of the title image to express in an easy-to-understand manner the content of the plant information screen) for each kind of the plant information screen. This improves the functionality of the title image and also improves the operability of the plant information screen display.

According to the present invention, the plant monitor-control system mentioned above is characterized in that the menu screen is displayed in compliance with the demand for its display after the preliminary processing for display thereof, which includes a step of judging whether the display of the title image has been specified for the image screen for which the display is demanded, a step of judging the kind of the plant information screen for which a judgment has been made in the step that the display of the title image has been specified, a step of generating the plant information screen to display the current state which displays the current state data for the plant information screen for which a judgment has been made in the step that it is the type to display the current state data of the plant process, and a step of producing the directly reduced image or the feature reduced image as the title image for the plant information image displaying the current state which has been produced in the step.

The arrangement mentioned above efficiently generates the plant information title containing title images and text titles arranged side by side. This improves the operability of the plant information screen display.

The plant monitor-control system according to the present invention mentioned above is characterized in that the plant information display screen attached thereto has well-improved operability.

### BRIEF DESCRIPTION OF THE DRAWING

FIG. 1 is a diagram showing the constitution of the plant monitor-control system according to one embodiment.

FIG. 2 is a diagram showing an example of the menu screen for the graphic information screen.

FIG. 3 is a diagram showing an example of the menu screen for the historical current trend information screen.

FIG. 4 is a diagram showing an example of the mixed menu screen.

FIG. 5 is a diagram showing how the plant information screen is displayed when the title image is specified with the menu screen.

FIG. 6 is a diagram showing the constitution of the title image registration device and the menu screen displaying device.

FIG. 7 is a diagram showing an example of the title image type specifying dialog superimposed on the menu screen.

FIG. 8 is a diagram showing an example of the constitution of the menu screen data.

FIG. 9 is a diagram showing the flow of the processing of the menu screen display.

### DESCRIPTION OF THE PREFERRED EMBODIMENTS

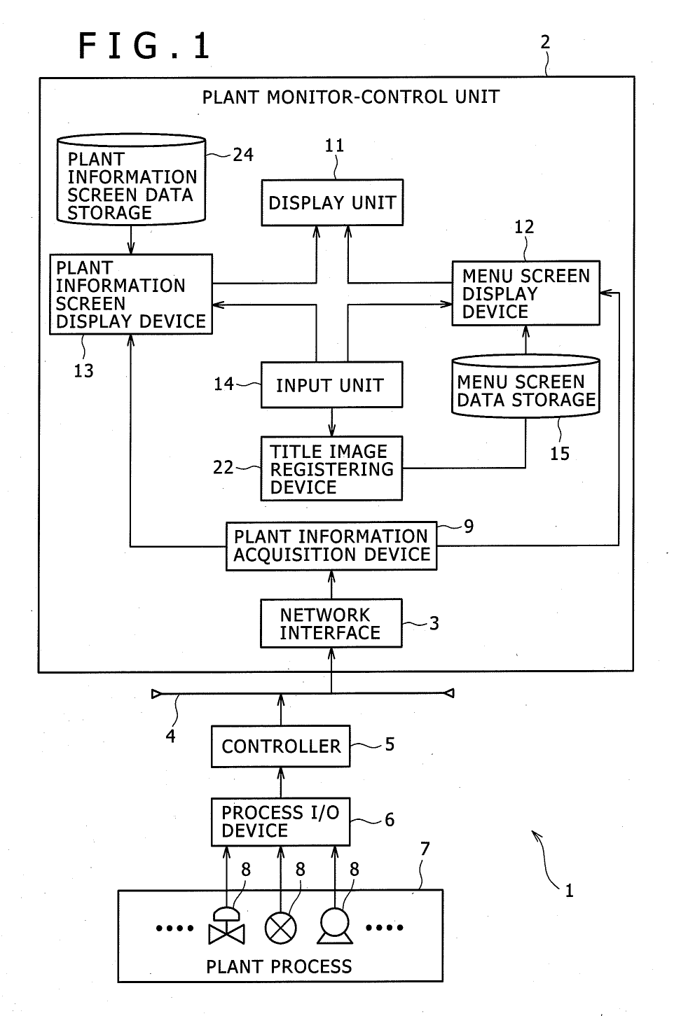

The following deals with the embodiment of the present invention. FIG. 1 is a block diagram showing the plant monitor-control system according to the embodiment. The plant monitor-control system 1 has the plant monitor-control unit 2.

The plant monitor-control unit 2 is connected to the network 4 through the network interface 3. It is also connected to a variety of equipment 8 for the plant process 7 through the network 4, the controller 5, and the process I/O device 6 which are sequentially connected one to the other. It displays on the plant information screen the plant information, such as the state of the equipment 8 and the data measured by the equipment 8, which is acquired from the plant process 7 through the plant information acquisition unit 9. Although it permits the operator to monitor and control the plant process in response to what is displayed on the plant information screen, FIG. 1 shows only the plant information screen characteristic of the present invention but does not show the plant information screen for monitor and control in general.

Also, the plant monitor-control unit 2 has the display unit 11 for the plant information screen. The display unit 11 is made to actuate the plant information screen by the menu screen display device 12 and the plant information screen display device 13.

For display on the plant information screen, the operator (not shown) asks the menu screen for display through the input unit 14. The menu screen display device 12 generates and displays the menu screen; upon receipt of a request for display on the menu screen, it generates the menu screen as requested and causes the display unit 11 to display it. For this process, it acquires menu screen data from the menu screen data storage device 15. Using the thus acquired menu screen data, it generates the menu screen to be displayed as will be mentioned later and causes the display unit 11 to display it.

The plant monitor-control unit 2 acquires plant information which is usually classified into graphic information, historical trend information, operation history information, message information, document information, and alarm information, as mentioned above. This classification is also used to divide the plant information screen into several sections corresponding to the type of information listed. The menu screen is usually available in several kinds according to the type of plant information. In other words, it includes those for graphic information, historical trend information, operation history information, message information, document information, and alarm information. Some of these screens may be combined together. The operator enters a demand for menu screen display so that the display unit 11 displays a list of titles for the menu screen, and then the operator selects a desired menu screen from the list.

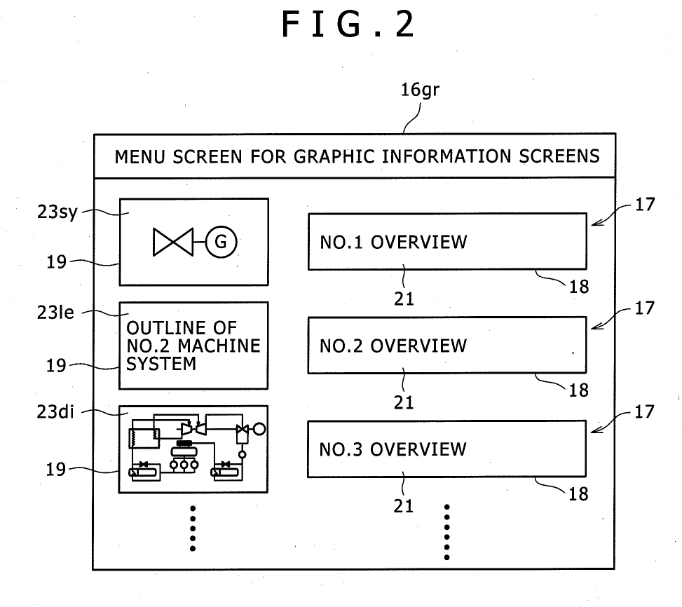

FIGS. 2 to 4 show some examples of menu screens, which are designated as graphic information menu screen (16gr), historical trend information menu screen (16hi), and mixed menu screen (16ml), respectively. As shown in these examples, the menu screen 16 is so constructed as to display some of the plant information titles 17 all at once.

The plant information title 17 contains sets of the text title display region 18 and the title image display region 19 which are placed side by side. The text title display region 18 displays the test title 21. The title image display region 19 displays the title images 23 (23di, 23ch, 23sy, 231e, and so on), if the demand for title image display is registered in the procedure for title image registration to be carried (as will be mentioned later) by means of the title image registering device 22 shown in FIG. 1. Consequently, the plant information title 17 may consist of the text title 21 and the title image 23 (in pairs) which are placed side by side; alternatively, it may contain the text title 21 alone. The text title 21 is a character string (or text data) describing the content of the plant information screen or its corresponding plant information. The title image 23 is an image (bitmap data, vector data, etc.) which symbolically represents the content of the plant information screen or its corresponding plant information. The title image 23 is classified into several types (listed below) according to the content and kind of the plant information and the plant information screen.

The types of the title image 23 include:
the directly reduced image formed by reducing the plant information screen (as such) corresponding to the plant information title 17.
the feature reduced image formed by reducing the feature extracted from the plant information screen corresponding to the plant information title 17.
the equipment symbol image formed with equipment symbols contained in the plant information screen corresponding to the plant information title 17.
the text image formed with a character string to briefly represent the content of the plant information screen or its plant information or the text title paired with the title image.
the free image formed from any image produced by the operator.

The text image or free image permits the title image to contain information (in an image form) about relation among plant information screens. (“Relation” means, for example, the sequence in which the screen for A plant information is displayed and then the screen for B plant information is displayed, or the situation in which the screen for C plant information and the screen for D plant information are displayed simultaneously if the display unit 11 is capable of displaying a plurality of plant information screens simultaneously.) The title image formed in this manner makes it easier to handle the plant information screens.

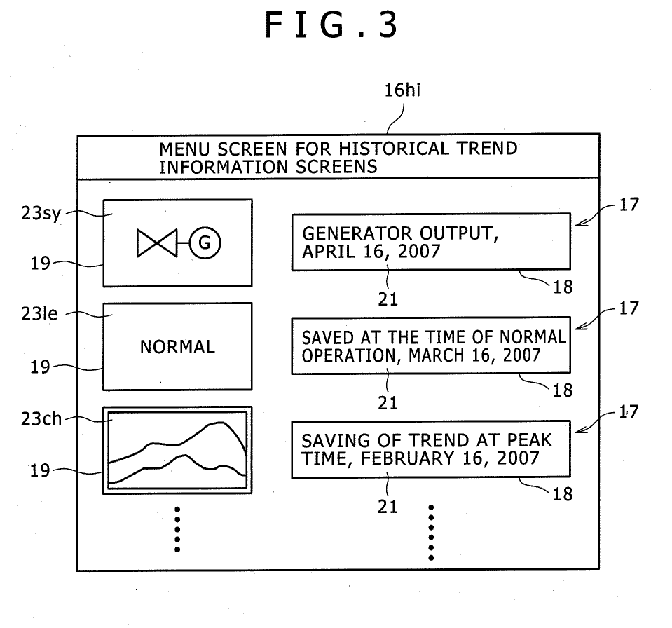

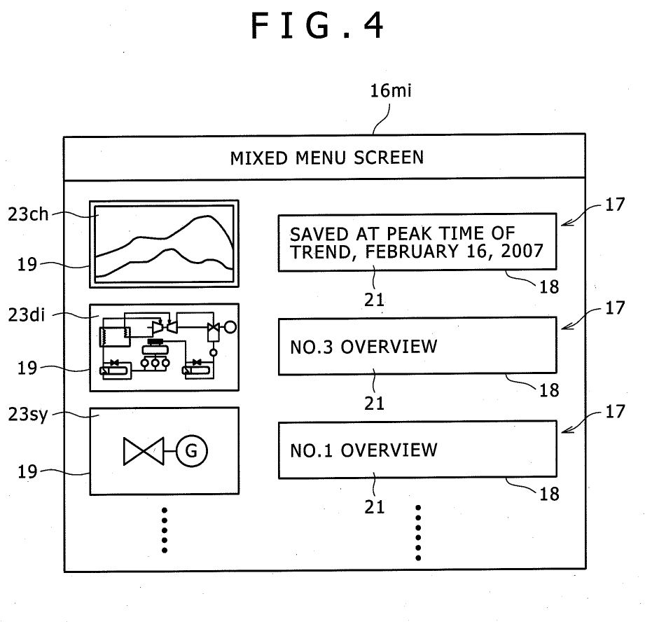

The title image 23di in FIGS. 2 and 4 is an example of the directly reduced image and it represents a graphic information screen. The title image 23ch in FIGS. 3 and 4 is an example of the feature reduced image and it represents a historical trend information screen. The title image 23sy in FIGS. 2 to 4 is an example of the equipment symbol image and it symbolizes the turbine and generator for the graphic information screen showing the system diagram of the turbine and generator. The title image 231e in FIG. 2 is an example of the text image and it briefly represents the content of the plant information screen for “Outline of the second machine system”. The title image 231e in FIG. 3 is also an example of the text image and it briefly represents with “NORMAL” the content of plant information screen. These title images 23 are produced when the menu screen display device 12 displays the menu screen, as will be mentioned later.

When the menu screen (mentioned above) is displayed on the display unit 11, the operator specifies the plant information screen as indicated by the plant information title 17 on the menu screen. This procedure is accomplished by moving the pointer or cursor to the text title 21 or the title image 23. Upon specification of the plant information screen, the plant information screen display device 13 takes out the plant information screen data from the specified plant information screen from the plant information screen data storage 24 and produces the plant information screen for display using it. The process of producing the plant information screen varies depending on the kind of the plant information screen. In the case where the plant information screen is one which displays the current state data of the plant process (or it is the plant information screen showing the current state, such as the graphic information screen), it generates the plant information screen showing the current state by combining the current state data of the plant process, which has been obtained by the plant information acquisition device 9, with the plant information screen data. On the other hand, in the case of the plant information screen other than the plant information screen showing the current state, it uses the plant information screen data as such and generates the plant information screen for display. After the plant information screen for display has been generated in this manner, the plant information screen display device 13 displays it on the display unit 11. Here, a typical example of the plant information screen showing the current state is the graphic information screen. In the case of the graphic information screen, it displays the data value on the tag to be attached to the equipment symbol contained in the graphic information screen or it colors the equipment symbol contained in the graphic information screen, thereby displaying the current state.

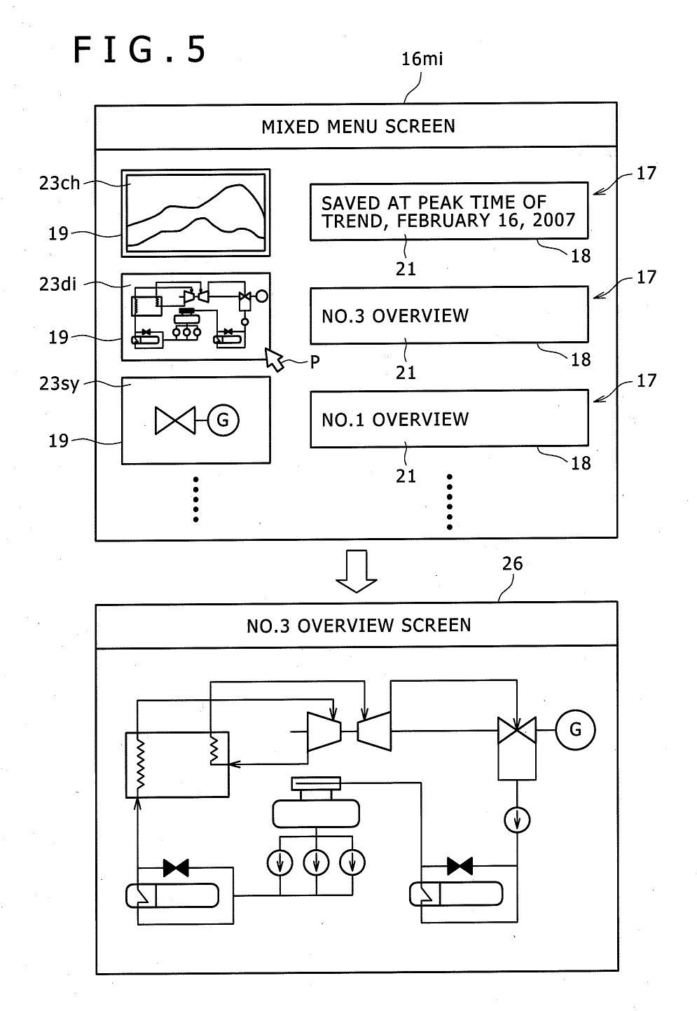

FIG. 5 shows the process by which the plant information screen 26 for No. 3 overview is displayed as the result of specifying the title screen 23di with the pointer P in the type-mixed menu screen 16ml shown in FIG. 4. In this case, the title screen 23di is an image formed by reducing the plant information screen 26 as such because it is a directly reduced image. Incidentally, the plant information screen 26 displays the current state in the plant process by means of tags or colors the equipment symbols because it is a graphic information screen for the current state of the plant process relative to the process system; however, such display is omitted in FIG. 5.

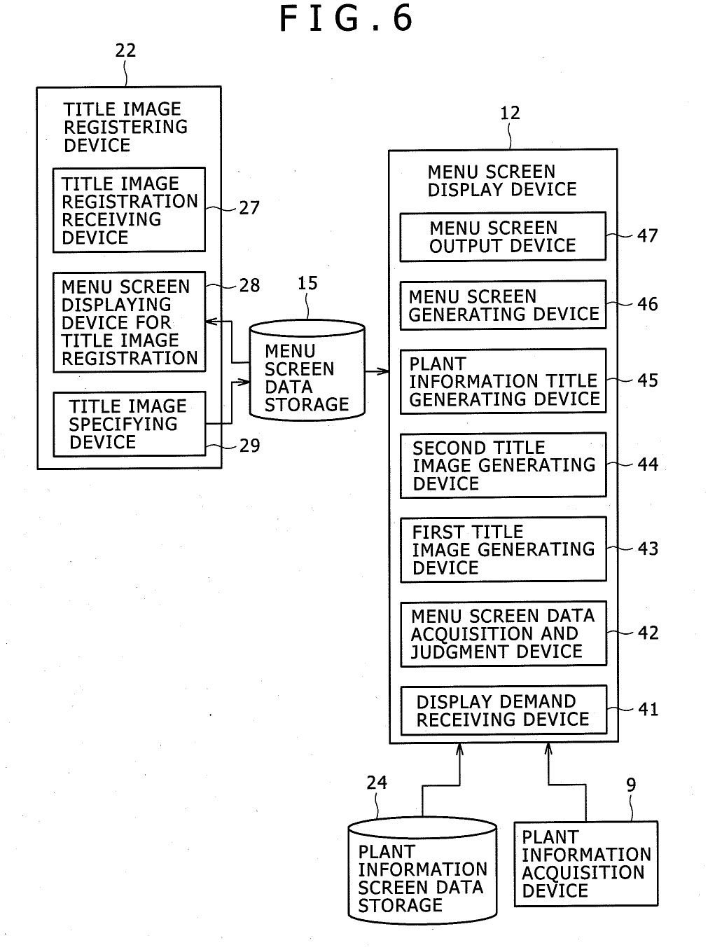

FIG. 6 shows the configuration of the title image registering device 22 and the configuration of the menu screen display device 12, together with the relation between them. The title image registering device 22 contains the title image registration receiving device 27, the menu screen displaying device for title image registration 28, and the title image specifying device 29.

The title image registration receiving device 27 receives the registration of the title image as the operator selects the icon of the title image registering device 22 which appears on the display unit 11.

The menu screen displaying device for title image registration 28, upon reception of registration by the title image registration receiving device 27, acquires the menu screen data from the menu screen data storage 15 and, with the help of it, generates and displays the menu screen for registration of the title image, as will be mentioned later. If there are more than one kind of menu screens as mentioned above, the menu screen for registration of title image by the menu screen displaying device for title image registration 28 displays a list of menu screen titles so that the operation chooses the desired menu screen from the list of the menu screen title. After the menu screen for title image registration has been displayed, the operator specifies the plant information title to be registered for display of title image from the plant information title contained therein.

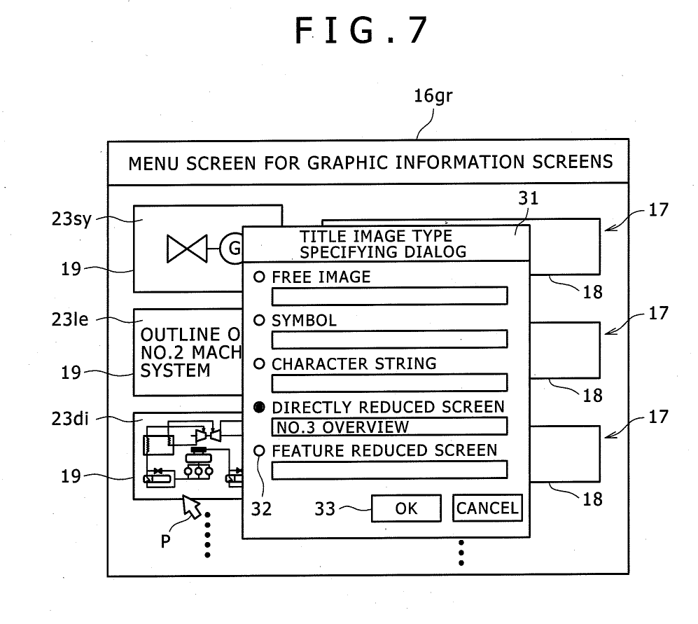

After the operator has specified the plant information title to be registered, the title image specifying device 29 displays the screen for the operator to specify the type of the title image. FIG. 7 shows an example thereof. The example shown in FIG. 7 represents the case in which the title image type specifying dialog 31 is displayed as the type specifying screen. The title image type specifying dialog 31 has a list showing the types of the title images that can be specified, which are designated as free image, equipment symbol image, character string image, directly reduced image, and feature reduced image. In addition, the list has check buttons 32 for individual type names, and each type name has a text title displayed thereunder for confirmation. This text title is that of the plant information screen to be registered for display demand. The operator specifies the type of the title image by selecting the check buttons 32 in the title image type specifying dialog 31.

When the title image to be produced manually is specified, a screen to specify the content of the title image and to produce the title image (which helps specify the image content and produce the image) is displayed as a dialog. (The title image to be produced manually includes equipment symbol image, text image, and free image, which are to be produced as the operator manually specifies the content of each title image or prepare each title image.) The operator specifies the content of the title image or produces the title image with the help of the title image type specifying dialog 31, and the operator also presses the OK button, with the result displayed in the title image type specifying dialog 31. In this way the title image is registered. On the other hand, in the case where the title image, such as directly reduced image and feature reduced image, which is formed by automatically reducing the plant information screen, is specified, the operator presses the OK button 33 after specification, so that the title image is registered. In the example shown in FIG. 7, the directly reduced image is specified by selecting the check button 32 for the plant information screen in which the text title reads “No. 3 Overview”, and the text title reading “No. 3 Overview” is displayed under the type name “directly reduced image”. Pressing the OK button 33 in this state causes the title image 23di to be registered for the plant information title 17 of the plant information screen of “No. 3 Overview”.

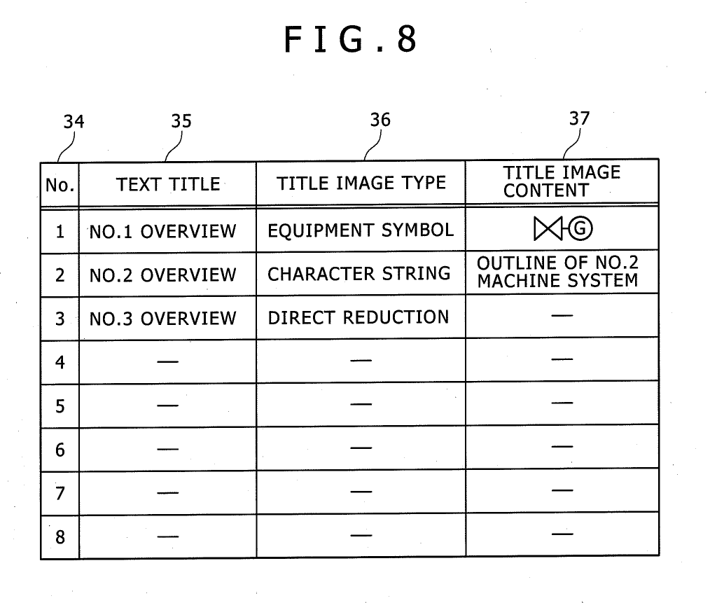

Registration of display demand mentioned above is repeated for each menu screen as many times as the operator thinks necessary. Theses steps renew the menu screen data of the menu screen data storage 15. FIG. 8 shows an example of the configuration of the menu screen data. The menu screen data of this example has the tabular form composed of the following four columns. Number column 34 to record the number to be attached to the plant information title in the order of display in the menu screen. The text title column 35 to record the text title. The title image type column 36 to record the presence or absence of registration of the display demand of the title image or to record the type of the title image if the display demand is registered. The title image content column 37 to record the image content (which may also be the original of the title image) which has been manually produced. That the registration of the display demand of the title image is “none” is registered in the title image type column 36 by leaving it blank or by recording “none” in it.

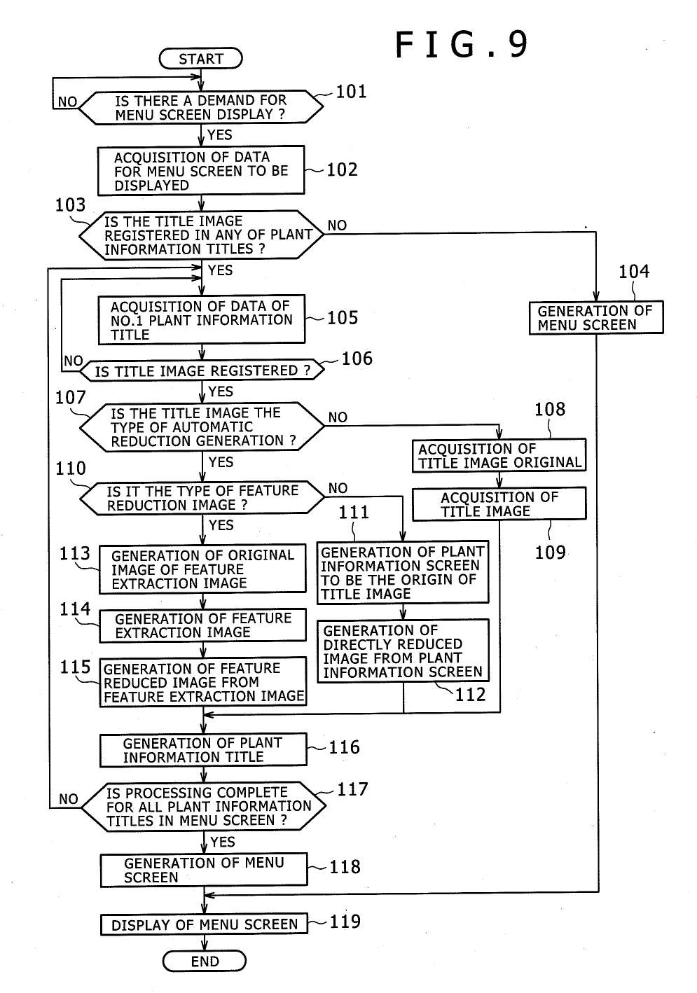

Returning to FIG. 6, in which the menu screen display device 12 includes the display demand receiving device 41, the menu screen data acquisition and judgment device 42, the first title image generating device 43, the second title image generating device 44, the plant information title generating device 45, the menu screen generating device 46, and the menu screen output device 47. The process for displaying the menu screen by the menu screen display device 12 is accomplished according to the flow shown in FIG. 9. The process shown in FIG. 9 includes Step 101 to Step 119, and these steps except for the last are intended for preparation of the menu screen display.

In Step 101, the display demand reception device judges whether there is a demand for display of the menu screen. If there is a demand for display, the process proceeds to Step 102. In Step 102, the menu screen data acquisition and judgment device 42 acquires from the menu screen data storage 15 the menu screen data of the menu screen for which there is a demand for display. In Step 103, a judgment is made for the menu screen data acquired in Step 102 about whether there is a registration of demand for display of the title screen in the plant information title contained therein.

If a judgment is made in Step 103 that there is no registration of demand for display, the process proceeds to Step 104. In Step 104, the menu screen generating device 47 generates the menu screen as shown in FIGS. 2 to 4 (no display in the title image display region 19) from the menu screen data acquired in Step 102. Then, the menu screen generating device 47 sends the menu screen to the display unit 11, so that the menu screen is displayed in Step 119 and the process ends.

On the other hand, if a judgment is made that there is a registration of demand for display in Step 103, the process proceeds to Step 105. In Step 105, the data of the plant information title of No. i (i=1 to n) is acquired from the new screen data which has been acquired in Step 102.

In Step 106, a judgment is made whether there is a registration of demand for display of the title image for the plant information title data which has been acquired in Step 105. If a judgment is made in Step 106 that there is no registration of demand for display in Step 106, the process returns to Step 105. On the other hand, if a judgment is made that there is a registration of demand for display in Step 106, the process proceeds to Step 107.

In Step 107, the menu screen data acquisition and judgment device 42 judges whether the title image in the plant information title which was acquired in Step 105 is that of automatic reduction generation type. To be more specific, judgment is made by asking “Is the title image is of the automatic reduction generation type?” If the case of negative judgment, the process proceeds to Step 108. In Step 108, the menu screen data acquisition and judgment device 42 acquires the content of image or the original of the title image from the relevant plant information title. Then, in Step 109, the second title image generating device 44 adjusts the original of the title image to a size suitable for display in the title image display region 19, thereby generating the title image, and subsequently, in Step 116, the plant information title generating device 45 carries out processing to display the title image in the title image display region 19, thereby generating the plant information title to display the title image.

On the other hand, in the case where a judgment is made in Step 107 that it is of the automatic reduction generation type, the process proceeds to Step 110. In Step 110, the menu screen data acquisition and judgment device 42 judges whether the title image is of the feature reduced image type. To be more specific, a judgment is made by asking “Is the title image is of the feature reduced image type?”

In the case where judgment is made in Step 100 that it is not of the feature reduced image type, it is of the automatic reduction generation type and hence the process proceeds to Step 111. In Step 111, it acquires the current plant information through the plant information acquisition device 9 and it generates, by using the plant information, the plant information screen which becomes the original of the title image of the directly reduced image type. Then, the first title image generating device 43 reduces the plant information screen which has been generated in Step 111 into a size suitable for display in the title image display region 19, thereby generating the title image of directly reduced image type (or the directly reduced image) in Step 112. In Step 116 that follows, the plant information title generating device 45 carries out a process to display the title image in the title image display region 19, thereby generating the plant information title for title image display.

On the other hand, if a judgment is made in Step 110 that it is of the feature reduced image type, the process proceeds to Step 113. In Step 113, the first title image generating device 43 acquires the current plant information through the plant information acquisition device 9 and generates, by using the plant information, an image as the original of the feature extracting image. Then, in Step 114, the first title image generating device 43 extracts the feature part from the original image of the feature extracting image, thereby forming the feature extracted image. In Step 115, it reduces the feature extracted image into a size for display in the title image display region 19, thereby forming the title image of the feature reduced image type (or the future reduced image). Subsequently, in Step 116, the plant information title generating device 45 processes the title image for display in the title image display region 19, thereby forming the plant information title for display of the title image.

Here, extraction of the feature from the original image for the feature extraction image is carried out, in the case of the title image for the plant information title of the current trend information screen as a typical example of the title image of feature reduction image type, by defining that data part, which is higher or lower than the upper or lower limit predetermined for the historical trend data or which is higher or lower than the upper or lower limit of the amount of change per unit time predetermined for the historical data, as the feature part and on the basis of this definition.

In Step 117, a judgment is made to see whether the desired processing has been performed on all of the plant information titles containing the menu screen which is being processed currently. If the result of judgment in Step 117 is negative, the process returns to Step 105 and Steps 105 to 117 are repeated until the result of judgment in Step 117 becomes affirmative.

If judgment in Step 117 is affirmative, the process proceeds to Step 118. And the menu screen generating device 46 generates the menu screen by each plant information title obtained by the processing up to Step 117. In Step 119, the menu screen output device 47 sends the menu screen to the display unit 11 so that the menu screen is displayed, and the processing comes to an end.

As mentioned above, the plant monitor-control system 1 constitutes the plant information title 17 with the text titles 21 and the title images 23 which are arranged side by side, and it forms the menus screen 16 that lists the plant information title 17. Therefore, it compensates for each other's shortcomings of the text title 21 and the title image 23 which present difficulties in interpretation of plant information titles (or the text title 21 presents difficulties in grasping the content of the plant information screen and the title image 23 presents difficulties in interpretation of the plant information title for similar plant information screens). The foregoing permits the operator to rapidly judge the content of the plant information title and hence makes it easy to display the plant information screens.

The present invention has been described above with reference to some embodiments; they are merely typical ones, and the present invention will be practiced in various modes without departing from the scope thereof.

What is claimed is:

1. A plant monitor-control system wherein a display unit displays thereon a menu screen that includes a plant information title prepared for each of a plurality of plant information screens displayable on said display unit, said display unit displaying thereon desired plant information screens upon selection of said plant information titles in menu screens displayed thereon, thereby permitting monitor and control of a plant according to plant information screens displayed on said display unit,
wherein said plant information title in said menu screen is displayed in the region including a text title display region and a title image display region, said text title display region displaying a text title composed of a character string, said title image display region displaying a title image composed of an image representing the content of said plant information screens.

2. The plant monitor-control system as defined in claim 1, wherein said plant information screens can be displayed on said display unit also by selection of said title image displayed in said title image display region.

3. The plant monitor-control system as defined in claim 1 or 2, wherein said title image contains
an directly reduced image formed by reducing the plant information screen as such to be displayed by said selection,
a feature reduced image formed by reducing the feature extracted from the plant information screen to be displayed by said selection,
an equipment symbol image formed with equipment symbols contained in the plant information screen to be displayed by said selection,
a text image formed with character strings to briefly represent the content of the plant information screen or said text title to be displayed by said selection, and
a free image formed from any image to be produced freely,
said title images of various types being used individually according to the content and type of said plant information screens.

4. The plant monitor-control system as defined in claim 3, wherein said menu screen is displayed in compliance with the demand for its display after the preliminary processing for display thereof, which includes
a step of judging whether the display of said title image has been specified for the image screen for which said display is demanded,
a step of judging the kind of the plant information screen for which a judgment has been made in said step that the display of the title image has been specified,
a step of generating the plant information screen to display the current state which displays the current state data for the plant information screen for which a judgment has been made in said step that it is the type to display the current state data of the plant process, and
a step of producing said directly reduced image or said feature reduced image as said title image for the plant information image displaying the current state which has been produced in said step.

5. A method for plant monitor and control which comprises
displaying on a display unit a menu screen that includes a plant information title prepared for each of a plurality of plant information screens, said plant information screen including a text title display region and a title image display region, said text title display region displaying a text title composed of a character string, said title image display region displaying a title image representing the content of said plant information screens, and
displaying the desired plant information screen on said display unit by selecting said plant information title on the menu screen displayed on the display unit.
